(19) United States
(12) Patent Application Publication
(10) Pub. No.: US 2023/0237431 A1
(43) Pub. Date: Jul. 27, 2023

(54) DISTRIBUTED DEVICE USAGE FOR PLANOGRAM GENERATION

(71) Applicant: Grabango Co., Berkeley, CA (US)

(72) Inventors: William Glaser, Berkeley, CA (US); Ryan L. Smith, Berkeley, CA (US)

(21) Appl. No.: 18/158,900

(22) Filed: Jan. 24, 2023

Related U.S. Application Data
(60) Provisional application No. 63/302,439, filed on Jan. 24, 2022.

(51) Int. Cl. G06Q 10/087; H04W 4/029; G06Q 30/0601

(52) U.S. Cl. CPC G06Q 10/087; H04W 4/029; G06Q 30/0639

(57) ABSTRACT

A system and method for mapping product locations that can include: receiving, through a digital delivery ordering service, a plurality of orders, wherein each order includes a product list of products for delivery from a retail environment; assigning each of the plurality of orders to a user account of a plurality of user accounts for fulfillment of the orders; building a location dataset associating location data points and products, comprising for each order: determining an order to be undergoing fulfillment in association with a mobile computing device linked with the user account of the order, during fulfillment of the order, collecting location data points for products of the product list using input from the mobile computing device; and processing the location dataset for associations between the location data points and products and thereby determining an updated product location map.

### CROSS-REFERENCE TO RELATED APPLICATIONS

This application claims the benefit of U.S. Provisional Application No. 63/302,439, filed on 24 Jan. 2022, which is incorporated in its entirety by this reference.

### TECHNICAL FIELD

This invention relates generally to the field of automated inventory monitoring and more specifically to a new and useful system and method for planogram generation using distributed devices.

### BACKGROUND OF THE INVENTION

Wayfinding is a significant problem for delivery services in modern grocery stores. Stores can be tens of thousands of square feet and have 100,000 or more SKUs (Stock-Keeping Units) located within them. Finding all the items on a given shopping list can be a challenge, and one that's exacerbated when shoppers, or SKU pickers, are new to the store. Moreover, routing a path to collect items efficiently relies heavily on having an up-to-date planogram that accurately shows where everything is in a store, and what is out of stock. To keep an accurate map of product locations in a store, many existing solutions rely on very manual process of systematically checking all inventory solutions. In some more technological solutions, some stores have explored using robotic devices to systematically move through a store and catalog inventory. Both solutions are slow, expensive, and fail to provide real-time updates on changing conditions in a store.

Thus, there is a need in the automated inventory monitoring field to create a new and useful system and method for planogram generation using distributed devices. This invention provides such a new and useful system and method.

### BRIEF DESCRIPTION OF DRAWINGS

FIG. 1 is a schematic representation of a system variation.

FIG. 2 is a flowchart representation of a method variation.

FIG. 3 is a flowchart representation of a method variation used across multiple users.

FIGS. 4-6 are flowchart representations of method variations used across multiple orders.

FIG. 7 is a schematic representation of an exemplary implementation of a method variation.

FIG. 8 is a schematic representation of application interactions used to collect location data.

FIG. 9 is a schematic representation of collecting image data from an application to facilitate updating product fulfillment status and collect location data.

FIG. 10 is a schematic representation of collecting location data on adjacent products detected in collected image data.

FIG. 11 is a schematic representation of location data points mapped for an example product A.

FIG. 12 a schematic representation of location data points mapped for an example product A factoring in recency of the location data points to predict product location.

FIG. 13 is a flowchart representation of a method variation for a scan-and-go application.

FIG. 14 is a schematic representation of processing multiple shopping paths associated with different sets of products to predict a location of an example product A.

FIG. 15 is a schematic representation of an application providing navigational instructions and user interactions with navigation user interface element triggering collection of location data points for a focused product.

FIG. 16 is a schematic representation of using a visual mapping system to predict location of an input image based on a reconstructed map of a collection of images covering the environment.

FIG. 17 is a schematic representation of an exemplary interaction flow used to trigger a product resolution interaction and receive from an end customer a selected resolution.

FIG. 18 is a schematic representation of filtering location data to normalize location predictions and to provide a shelf location signal relating to likelihood of a product being positioned at a given point on a shelf.

FIG. 19 is an exemplary system architecture that may be used in implementing the system and/or method.

### DETAILED DESCRIPTION OF THE EMBODIMENTS

The following description of the embodiments of the invention is not intended to limit the invention to these embodiments but rather to enable a person skilled in the art to make and use this invention.

1. Overview

Systems and methods for product map generation can utilize product location detection through distributed use of an application. The systems and methods described herein enables a data processing system to synthesize pairings/associations of product-associated application usage and location detecting mechanisms of a personal computing device in order to generate a product map. The systems and methods introduce several new and innovative capabilities to a computer-implemented system whereby, for example, distributed usage of an application by multiple users may be transformed into a sensing mechanism for mapping product locations.

The systems and methods may have particular utility in retail environments where it can be useful to have updated information on locations of items (e.g., products) and where there are retail related activities facilitated through an application that may be transformed into part of a sensing system. Herein the systems and methods are primarily described in terms of their application within a retail environment, referencing products, but the systems and methods may be used in alternative use-cases with any suitable type of item or object.

The systems and methods enable an automated process based on a unique combination of specially configured computing systems. Location information may be collected in a way that can be directly or indirectly associated with product identifiers, and a predictive data processing system can process the collected data to create a probabilistic map of product locations. Products can be associated with location information based on product-related interactions triggered through user interactions with an application or device. In one exemplary use-case, application usage within a picker-application of a retail order fulfillment service may be used to build a database of product-location associations, which can then be used to predict product locations.

The systems and methods may be used in enabling various new capabilities. A resulting product location map may then be used in a variety of applications such as directing paths of users, producing a product map visual or data service (e.g., generating a retail planogram model), automated data reporting on inventory state, automated reporting on product display state, automating product picking, and/or other applications. In the variation where the systems and methods are used with retail order fulfillment, the product location map and/or the process of generating the product location map may be used to monitor picker compliance (e.g., did the picker properly visit a predicted product location before marking the item as not in stock), automating order picking status (e.g., automatically checking off an item from an order list after the picker visits a product location and is predicted to have picked the item), guiding the picker (e.g., providing navigation instructions), providing real-time customer communication for product changes/out of stocks, and/or providing other functionality.

As one exemplary use case, the systems and methods may be used in combination with a product delivery service application or as described herein an order fulfillment service. For example, a grocery delivery service may provide an application operable on a mobile device of “product pickers” of the service. The product pickers receive orders that include a list of items to be selected at a store and then purchased so that they or someone else can deliver an order of those items to an address of the orderer.

The systems and methods described herein may enable techniques for managing the activities of product pickers to facilitate the collection of items assigned identifiers (e.g., SKUs), and using learnings from that work to maintain a product location map or planogram that is leveraged for later product pickers. In particular, the systems and methods when implemented with integration with an application used by the pickers, may enable incremental accumulation of product associated location data that may be used to generate a product map.

In some variations, the systems and methods can be used in assisting users in picking items from shelves. In one example, pickers may have a recommended path generated for an order based on the state of the product map. In other example, the application may require the picker to take a picture to confirm they picked the item or to confirm the item is out of stock. Various automated checks may be performed to visually check if the product matches the target product from a product list, to check the picker is checking the right shelf section if the product is out of stock.

In some variations, the actions directed through the application may additionally drive other new capabilities of a system. For example, taking a photo within the store may be useful in providing confirmation of location data for a particular product, but other products identified within the image data (“adjacent products”) may also be detected, and collected location data can be associated with those products as well.

The systems and methods also can update the product location map based on real-time events reported through the picker application. For example, indication of an item being out of stock or being picked up from a new location may be used in updating the product map with current conditions.

In addition to or as an alternative to updating a product map, the systems and methods may also enable real-time/reactive order adjustments based on different conditions during operation of the picker application. If the picker for a particular order, another picker with a different order but with a shared item of the order, or otherwise detected through the product map indicates that a particular item is not in stock (or even low in stock), the systems and methods may proactively initiate communicating with the orderer to receive a resolution option. For example, if the systems and methods detect that an order including a particular type of breakfast cereal is out of stock or low in stock (potentially after the order is already submitted), a message could be sent to the orderer requesting input on what action to take. For example, the orderer may receive a push or text message indicating the situation and asking if “a backup product” should replace the cereal or if the picker should skip that item if it's not available. In some variations, this may all happen before the picker even begins processing the order such that time is not wasted waiting for instructions from the orderer or potentially even receiving instructions after the order is completed.

The systems and methods can be used with a variety of different types of applications and/or devices. As discussed, in one example, the application used in collecting location data would be one used with an order fulfillment service such as a grocery delivery service application.

The systems and methods may additionally or alternatively be used with a shopping list app. This could be an app used by customers of a retail environment to manage their shopping list. By checking off items in the app, automatically collected data relating product information and location can be collected.

The systems and methods may additionally or alternatively be used with a scan-and-go checkout application. A scan-and-go checkout application is used to characterize a type of application that is usable by customers as an alternative to traditional checkout. Such an application may be used by a user to scan items as they browse the retail environment in order to purchase that item or add that item to their cart. While using such an application, data generated while users scan items can also be used in generating a product location map.

The systems and methods may additionally or alternatively be used with an operations-related application. For example, an inventory stocking application or stocking device (e.g., a barcode scanner) may be used as a source of location associated product data.

The order fulfillment application will be used herein as one exemplary use case. However, alternative types of applications may alternatively or additionally be used.

The systems and methods may be used with one or more different location detecting approaches.

In one variation, the systems and methods interface with a computing device of a user through an application operable on a mobile computing device. The mobile computing device could be a smart phone, smart glasses, a smart watch, audio device, alternative wearable computing device, and/or any suitable type of computing device usable by a user throughout the environment.

In another variation, the systems and/or methods may interface directly with a device such as a barcode scanning device, a location detection device, or other suitable type of device.

In some variations, the device and/or application could be operated without data related directly to products. Instead, the device may report location of a user/account, and the user/account can be associated with product information (e.g., a shopping list assigned to that user).

An application and/or device may use one or more different techniques for determining location such as GPS; wireless communication triangulation; magnetic sensing; position tracking using accelerometer, gyroscope, and/or other type of inertial measurement system; RFID tracking, Bluetooth proximity/location tracking, ultrawide band (UWB) location tracking, computer vision location tracking; and/or other location detection techniques.

In some variations, collected image data using a device of the user, may be used to predict the location of the user. Preferably, with enough usage, a visual mapping of the retail environment may be established using a multitude of images (e.g., hundreds or thousands of photos). Preferably a visual mapping system will have image coverage over the majority of the environment if not more than 90% or possibly more than 99% of the stocking space in the environment.

The system and method may provide a number of potential benefits. The system and method are not limited to always providing such benefits and are presented only as exemplary representations for how the system and method may be put to use. The list of benefits is not intended to be exhaustive and other benefits may additionally or alternatively exist.

As one potential benefit, the systems and methods may enable product location monitoring possibly without environment-installed product sensing infrastructure. Devices used by users moving within the environment can be used in building product location data across the environment.

As another potential benefit, the systems and methods can operate based on routine and frequent activities performed in a retail environment. This can make the systems and methods more easily deployed within existing environments.

As another potential benefit, the systems and methods can provide a way for a product location map to be routinely updated throughout the operating hours of the environment. Additionally, data on more popular items may naturally have more frequently updated location data. This can make the location data for more critical items being more accurate.

As another potential benefit, the systems and methods may lead to enhanced digital interactions with a retail order fulfillment service. For example, the product location map and its updates may be used to trigger dynamic communication with end customers and/or pickers for an improved user experience and/or more efficient picking.

As another potential benefit, the systems and methods may provide improved inventory insights. The resulting product location map may be used for a new automated planogram. Furthermore, inventory state and stocking state may be monitored through the systems and methods.

2. System

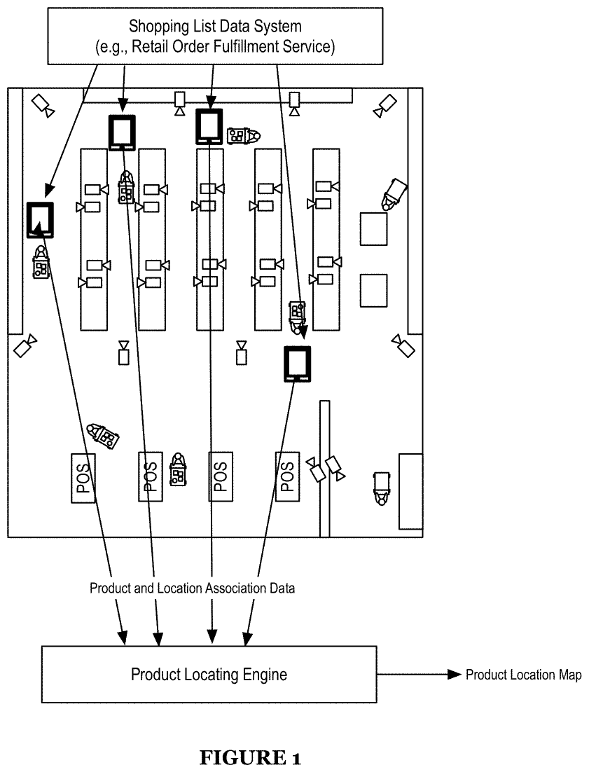

As shown in FIG. 1, a system for planogram generation and usage based on distributed device usage may include an interface 110 to a shopping list data system, a location tracking system 120 with integration with a set of mobile devices, and a product locating engine 130 configured to convert product-location instance data into a product location map.

The interface 110 to a shopping list data system functions to provide product information that can be used in determining which product identifier information to associate with relevant location information.

The interface 110 may be a data integration with an external data source. For example, an application programming interface (API) may enable the system to fetch or otherwise receive shopping list data from one or more outside services. For example, the interface 110 may interface with an order fulfillment service or a scan-and-go checkout service.

The interface 110 to a shopping list data system may alternatively have direct integration and possibly include the shopping list data system. For example, in some variations, the system is implemented by and may include a shopping list data system/platform, in which case an interface to such a system may or may not be used. For example, a retail order fulfillment service may implement the system and so the order system and relevant order tracking, task assignment, and/or other platform systems may be configured to facilitate providing access to relevant data.

When implemented as part of a retail order fulfillment service, the shopping list data used may be the list of items for one or more customers' orders. An order may be assigned to one or more pickers. Information on the set of items expected to be picked by a picker and possibly the item the picker is currently trying to pick can be used in combination with location data provided by the location tracking system 120.

In another variation, the interface 110 to shopping list data may provide product information after completion of a shopping trip. In such a variation, the interface 110 to shopping list data can include data integration to a checkout system, a point of sale (POS) system, and/or other source of items purchased or selected. With data on items purchased, this may be used to retroactively associate one or more of those items with location data collected prior to checking out (e.g., when the user was shopping in the store).

In other variations, the system may be implemented without an interface 110 to shopping list data, but instead use a product identifier and optionally integration with a product database. The product identifier can retrieve product identifying data of select products, either by looking up a product identifier like a product code, a barcode, a QR code, or other type of product identifier. For example, the system may be implemented using a scan-and-go type application, where a customer scans a product (e.g., the barcode or using CV product identification of the package) and this is used in identifying the product. As the customer scans products during the shopping trip, location information can be detected and associated with distinct product identification events. As another example, a device used by a worker during stocking or inventory operation tasks could similarly be used for pairing product identification with the location of the device at the time of scanning.

The location tracking system 120 functions to determine location information. The location tracking system 120 can use a location detection mechanism afforded by a mobile device and, as such, the location tracking system 120 may include integration with a set of mobile devices. This can be integration with an application operating on a mobile device or may alternatively be integration directly with a device.

The location tracking system 120 may pull location data from one or more location mechanisms such as GPS; wireless communication triangulation; magnetic sensing; position tracking using accelerometer, gyroscope, and/or another type of inertial measurement system; RFID tracking, Bluetooth proximity/location tracking, ultra-wide band (UWB) location tracking, computer vision location tracking; and/or other location detection techniques. The location tracking system 120 can use a location service of a computing device used by users of an application. Location data may be collected periodically or at particular times such as in response to different application events.

In another variation, the computing device may have a visual tracking system where in place of a location service, the device tracks spatial movements of the device within an environment. A device with such a visual tracking system may be used to also provide location data.

In one variation, the location tracking system 120 may collect a location data point associated with one or a limited set of products. The location data points may be collected so as to have predicted association with the stocking location of a product. As discussed, collection of the location data points may be in response to different application events. For example, when a shopper is detected to be picking a particular item, then location information may be determined and associated with that particular item.

In another variation, the location tracking system 120 tracks location of a user throughout a shopping session of a user. This may result in a set of products being associated with the set of locations of a user (e.g., associated with a shopping path of a user). In one example, the system may track location continuously or periodically during a visit so as to generate a store visit path. The shopping list for the user may associated with the path. With collection of sufficient data, the system may be able to detangle the paths so as to map products to specific locations. For example, with enough paths that include a particular variety of milk, the system can detect that all paths associated with that milk overlap in one particular location and therefor that particular location is likely the location of the milk.

Computer vision may be used in combination or as an alternative to absolute or relative location sensing. In a computer vision variation, an image of where the customer is picking an item may be used as a signature of where the user is in the store. An application may prompt the user to collect image data in association with different products from a product list. The image collection is preferably prompted to occur at or near where the product is stocked, possibly even instructing the user to take the picture of the product where it is stocked. With sufficient image data of a store, the setting of a picture could be mapped to a location in 3D space. This technique may employ photogrammetry, photo identification, and/or other photo mapping techniques.

In one variation, the camera of a mobile device is used to collect image data from the location of item selection. In one example, a user may take a picture of an item when it is picked up from the shelf. The product image data may be used to identify the product, while the background and other image data may be analyzed and used to determine where in the store that item was. In some variations, the background image of the shelf and/or orientation data of the mobile device when the picture was taken can be used to determine more precise stocking location. In this way, the system may be used to provide stocking information such as bin, shelf, and/or aisle data. As an alternative use case, a wearable camera, such as a pair of smart glasses may provide image data related to the view orientation of a user, this may be collected image data of the product before, during, and/or selecting the item. This can be used in collecting image data of where the product was stocked.

In addition to imaging devices of a mobile device, external imaging systems may also be used. For example, cameras installed in the environment may alternatively or additionally be used to track users and provide external location data for a user. This may be used to implement variations of the system, where the user may not have a participating mobile device. For example, a picker for a retail order fulfillment service may check in at a kiosk before a shopping visit, this enables the system to associate an order including a set of products with the user. When checking in, the kiosk could, for example, print out the items for the picker. Then the external imaging system can collect image data used to track the locations of the user through the store. In a related variation, a shopper may be tracked while shopping, and then when the shopper checks out all items can be retroactively associated with that shopper path. The product locating engine 130 with sufficient numbers of shopping paths, the product locating engine 130 can determine a predictive product location map.

The system can include a set of user applications and/or integrated mobile devices, which functions to collect location data and/or product information as a user moves through the environment interacting with products. The user application or mobile device can serve as a client used by a user performing some item related task (such as shopping, order fulfillment, stocking/inventory tasks, etc.). There are many variations on how such a client may be implemented. Some variations are described herein.

In one variation, the system includes a set of user application instances operable on mobile computing devices of a plurality of different users. The user application may provide some primary purpose. In one example, the user application can be an application of a retail order fulfillment service used by a picker when fulfilling an order of an end-customer. The application can include a graphical user interface that provides instructions but may also be used in collecting user input. In one example, the application is a smart phone application or an application on another type of device with a display. In one variation, the application could be part of a wearable computing device like an AR/VR/XR headset or smart glasses. These may include a camera to collect image data from perspective of the user. The application may additionally or alternatively include an audio user interface. Accordingly, some variations, may implement the system with smart headphones.

In some variations, a user application can include a scanning user interface. The scanning user interface can be used in scanning an item for product identification or providing a record of the items selected for purchase. A scanning interface may be used, for example, in a scan-and-go functionality that enables customers to scan an item to add to a checkout list or verify item selection.

In some variations, the user application can include a shopping list interface. The shopping list interface may be used to confirm an item was selected. In one example, a shopping list interface present in an application associated with a retail order fulfillment service, may be used by a picker to mark the items selected (or not for purchase).

The shopping list interface can additionally include user input options to retrieve data on item availability and stocking. An input element can enable a user to mark an item as available or picked (e.g., crossing an item off a shopping list, or marking it as added to cart). Another input element could be an option to mark that an alternative product was picked. This may be used to indicate that an item may not be in stock or at least may not be present at a particular stocking location. Another input element could be an option to mark an item as out of stock or not available. Other suitable types of input options may also be used.

At the time of interaction, location data may be logged by the location tracking system 120 and possibly associated with a particular product that received user interface interaction (e.g., checking item for pick up or marking as out of stock). Even if an item is marked as not in stock, the location of the picker at time of interaction may be an indication of probable location.

The product locating engine 130 functions to transform a dataset of instances of product and location associations into a product location map. In some variations, the output of the product locating engine 130 may be a product location map or planogram, which provides product stocking location information. The output could be a data model indicating location across the 2D floorplan of the environment. The output may, in some variations, be a data model indicating high resolution stocking information such as 3D stocking location and/or descriptive location data (e.g., shelf 4 in section 12).

The product locating engine 130 functions to process the data to create a product location prediction map. Repeated instances of a product having an association with a location can indicate that the product is likely in that location.

The product locating engine 130 can use multiple data points to predict location, repeated nearby location patterns for products reinforce product location. Product locations in multiple locations are also supported.

Product location changes can be accommodated by modeling changes in results. Time-based weighting of product-location input data may be used so that more recent data is weighted more strongly or otherwise amplified over older data. Additionally learning model may be used to predict when item locations change and adjust product location predictions. This can enable the product locating engine 130 to react to stocking changes in a store, like when a product is changed from being stocked in one location to another location.

3. Method

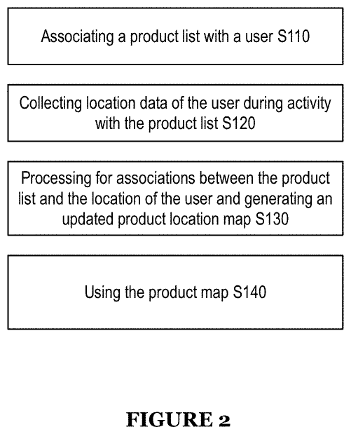

As shown in FIG. 2, a method for planogram generation using distributed device usage can include associating a product list with a user S110; collecting location data of the user during activity with the product list S120; and processing for associations between the product list and the location of the user and generating an updated product location map S130. The method may additionally include variations of using the product map S140 for actions such as responding to conditions in the product location map or inspecting the product location map in determining digital interactions of one or more system.

Block S110 and S120 are preferably implemented repeatedly across multiple store visits and/or across multiple users, which functions to build a plurality of datapoints from which patterns between locations and specific product may be detected. Data is collected so as to establish associations between product information and location-related data (e.g., tracked location of a user—usually facilitated by tracking a mobile device). When performed across a sufficient number of product lists and/or users, a location dataset can be built sufficiently large enough to predict product locations of specific products across an environment.

As used above, user may refer to an agent performing actions in the environment which could be identifiable within a computing system by a device or application instance associated with a corresponding user account. In some variations, user may be identifiable using an external sensing system used to track activity of users within an environment.

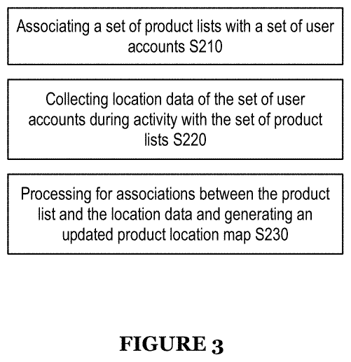

In many variations, the method is preferably implemented across multiple users and/or across multiple shopping lists (e.g., a plurality of products) such that a collective dataset can be built establishing associations between locations and products (e.g., specific product identifiers). Accordingly, as shown in FIG. 3, a variation of the above method may be implemented by a process including: associating a set of product lists with a set of user accounts S210, collecting location data of the set of user accounts during activity with the set of product lists S220; and processing for associations between the product list and the location data and generating an updated product location map S230. Variations of blocks S110, S120, S130, and S140 may be used with any of the blocks S210, S220, S230.

The method can enable a product location map to be passively generated through distributed fulfillment of diverse product lists. With collection of sufficient data points usable to relate a location data point and a product, a map of products may be generated. Such a product location map be determined, without any explicit tracking system in the store (though some variations may use environment installed tracking systems to facilitate enhanced location tracking and other features). in this way a store can enable improved product mapping with updated data, by deploying an application (which will generally have its own utility and function) specifically configured to provide such product mapping technology.

The method is preferably implemented by a system such as the one described herein, but any suitable system may alternatively be used.

The method may be used in mapping location of a plurality of products in a retail environment, but it may be used for mapping items in any suitable type of environment. Coverage and accuracy of the product location map may be improved and maintained with continued operation of the method. Accordingly, the method is preferably performed in whole or in part repeatedly. For example, multiple iterations of S110 and S120 may be performed. In another example, S110, S120, and S130 may occur repeatedly to repeatedly update the product location map. Similarly block S140 variations may be implemented any suitable number of times in connection with the product location map.

Some method variations enable additional new device-enabled capabilities. Such new capabilities may be used in different applied use-cases such as within an order fulfillment service. Method variations may use the processes described herein to automate auditing fulfillment by pickers (e.g., assessing quality and reliability to select products) and/or respond to changing inventory status.

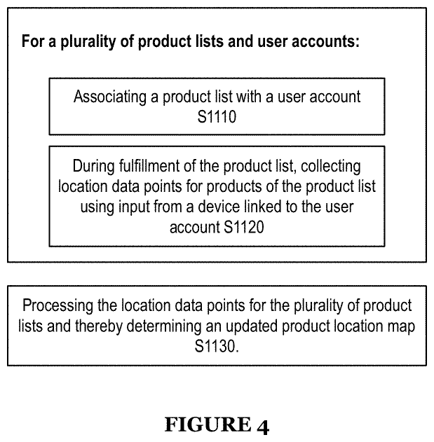

One such variation of the method used in association with multiple user accounts that have associated product lists (e.g., wherein a product list is a set of products for selection within an environment—for example, a product list could be delivery order for a set of products) may include as shown in FIG. 4, for a plurality of product lists and user accounts: associating a product list with a user account S1110; during fulfillment of the product list, collecting location data points for products of the product list using input from a device linked to the user account S1120; and processing the location data points for the plurality of product lists and thereby determining an updated product location map S1130. This may be used to generate a product location map or may be used to update an existing product location map.

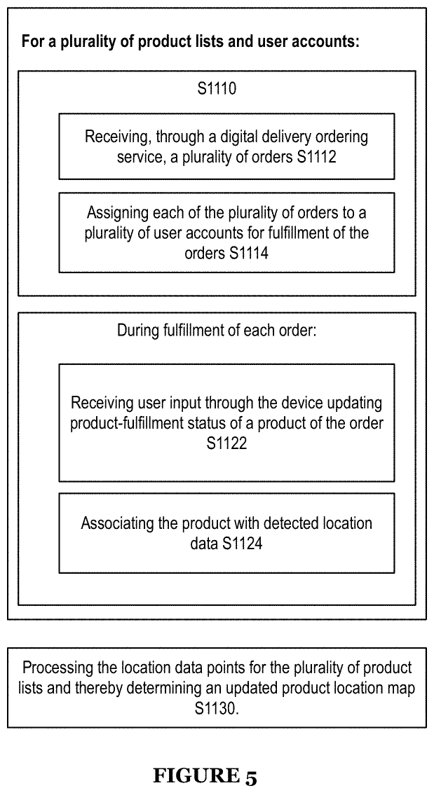

When used in connection with an order fulfillment service, this method variation may more particularly be implemented by a method variation of S1110 or S110 that includes: receiving, through a digital delivery ordering service, a plurality of orders, wherein each order includes a product list for items for delivery from a retail environment S1112; and assigning each of the plurality of orders to a user account of a plurality of user accounts for fulfillment of the orders S1114 as shown in FIG. 5. In one particular variation also shown in FIG. 5, S1120/S120 may include: during fulfillment of each order: receiving user input through the device updating product-fulfillment status of a product of the order (e.g., picked, not available, etc.) S1122 and associating the product with detected location data S1124. Location data could be detected by using a location service of the device (GPS, RF triangulation, etc.) or using visual data to predict location. The processing of datapoints for a plurality of products may include processing location data to identify patterns in the locations of different types of objects and using said patterns to predict the location of said objects. These patterns may be used to predict with high confidence where products are stored, when a product stocking location has changed, and/or if a product is confirmed to not be present at an expected location (e.g., out of stock).

Herein, blocks S1110, S1112, S1114, S1120, S1122, S1124, S1130 may be variations of one of S110, S120, S130, and/or S140, and any suitable variation described herein may similarly be used with such a method variation.

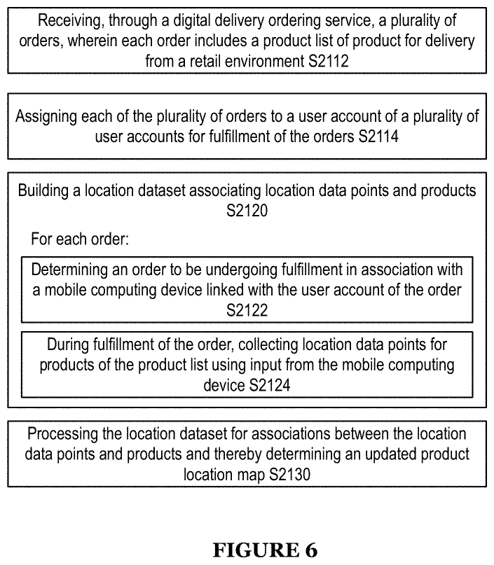

A method variation used in connection with order fulfillment may include, as shown in FIG. 6: receiving, through a digital delivery ordering service, a plurality of orders, wherein each order includes a product list of product for delivery from a retail environment S2112; assigning each of the plurality of orders to a user account of a plurality of user accounts for fulfillment of the orders S2114; building a location dataset associating location data points and products S2120 comprising for each order: determining an order to be undergoing fulfillment in association with a mobile computing device linked with the user account of the order S2122, and during fulfillment of the order, collecting location data points for products of the product list using input from the mobile computing device S2124; and processing the location dataset for associations between the location data points and products and thereby determining an updated product location map S2130. Herein, blocks S2112, S2114, S2120, S2122, S2124, S2130 may be variations of one of S110, S120, S130, and/or S140, and any suitable variation described herein may similarly be used with such a method variation.

In such a variation, each user account may be associated with at least one application instance on a different device for each user. In other words, the users will each have at least one mobile computing device, on which is installed an application instance that is associated with their account (e.g., logged into using their account). The location data points collected as part of S2120 and more broadly S120 may be described as candidate or potential location associations of a product.

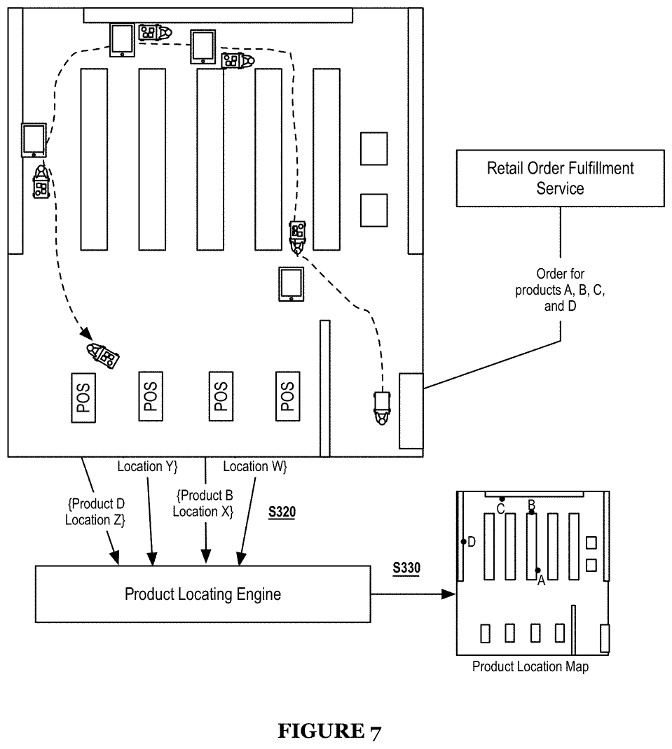

In one exemplary variation used in combination with a retail order fulfillment service and shown in FIG. 7, a method variation can include assigning an order to a picker and managing fulfillment interactions of the order on a picker application on a mobile device of the picker S3110, detecting location of the mobile device while completing fulfillment of the order S3120 resulting in an association of location with product identifiers, and after collecting associations of location and product identifiers for a plurality of orders, processing the associations and generating a product location map S3130. Herein, blocks S3110, S3120, and S3130 may be variations of one of S110, S120, S130, and/or S140, and any suitable variation described herein may similarly be used with such a method variation.

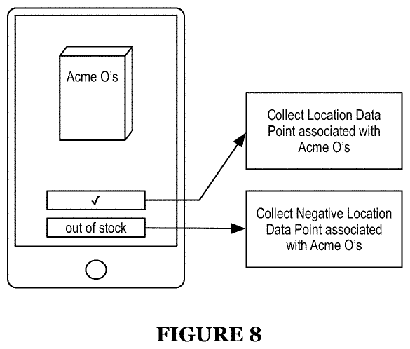

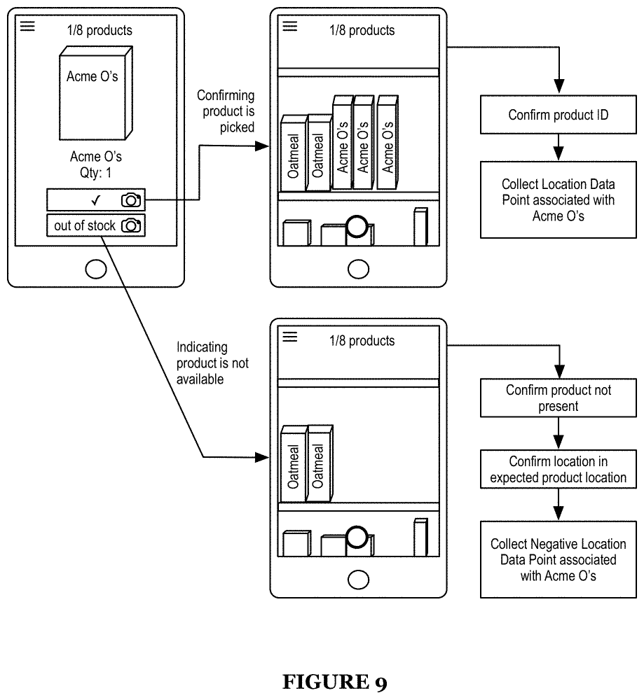

Managing fulfillment interactions can include providing a user interface that receives user input events signaling points in time when the picker is expected to be in proximity to a product or an expected location of the product (even if the product is out of stock). In one variation, the user interface may present input options to signal order fulfillment tasks such as indicating that a product was successfully picked up and added to “cart” or marking a product as out of stock or otherwise not available as shown in FIG. 8. When confirming an action indicating the product was present, a location data point associated with the product of the user input event is collected as a positive signal the product was at that location. When confirming an action indicating the product was not present, a “negative” location data point associated with the product of the user input event may be collected as a negative signal, indicating the product was not found at that location at that time. In another variation, a user interface may trigger a camera for collecting an image as a way of capturing image data of the task of “selecting” the product or optionally indicating the product is “not available/out of stock”. The image data may be processed as an additional or alternative mechanism for collecting location data and/or automatically reviewing stocking of products as shown in FIG. 9.

Detecting user input for such a product selection task can be associated with one or more corresponding products (e.g., product identifiers) and may also trigger associating location information with that one or more product. Accordingly, receiving input of such events preferably includes associating product identifiers for that task with location data from a time window associated with the event. In other words, a product identifier with focused state (e.g., selected, indicated as current product, etc.) in an application of a user can be associated with location data using temporal associations.

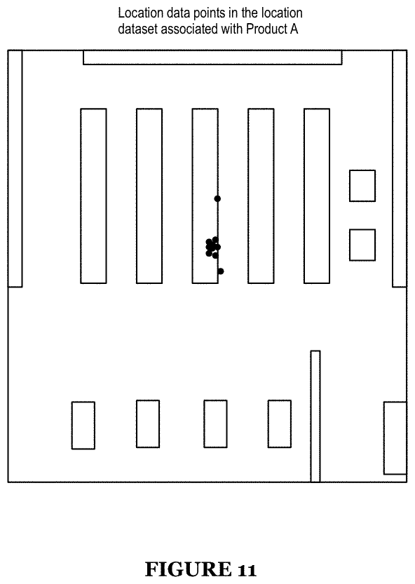

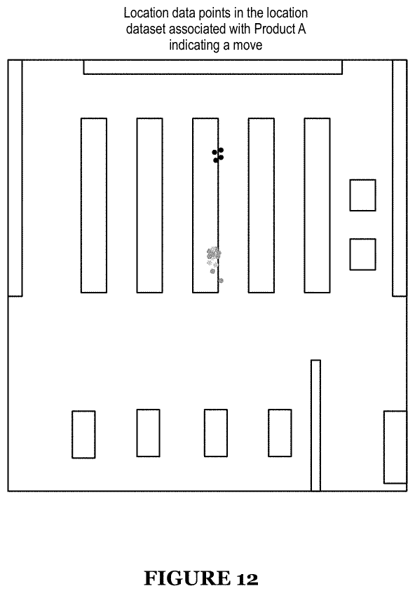

For example, a grocery delivery service may specifically customize their picker application such that as pickers are picking items within a store (e.g., marking an item as picked up or marking as not available), their location in the store can be associated with related items. With sufficient data for a given product and/or within an environment a product location map can be generated. As an example of how a particular cereal product may be mapped to a location, when multiple pickers pick the particular cereal product from the same location, that location can be predicted as the location of that cereal product. As shown in FIG. 11, a collection of location data points will generally cluster around a product location. Similarly, if suddenly the location shifts to a new location, the method can detect and predict a new location of this cereal product. Time recency of location data points may be factored into location prediction, similarly negative location data points (indication of a product not being at a location) may factor into detecting a change in location. As shown in FIG. 12, despite one location having more location data points (shown in grey), the more recent data points (shown in black) indicate the product moved to a newer location.

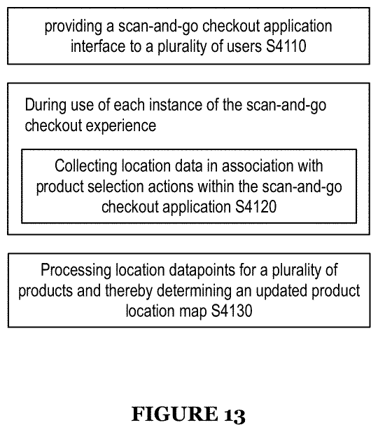

The method may alternatively be used in other use-cases. For example, a variation of the method may be implemented in connection with a scan-and-go application, where a scan-and-go application is an application configured for customers to scan items to add them to their checkout list or purchase as they browse the store. Such a method variation may include, as shown in FIG. 13: providing a scan-and-go checkout application interface to a plurality of users S4110, during use of each instance of the scan-and-go checkout experience, collecting location data in association with product selection actions within the scan-and-go checkout application S4120, and processing location datapoints for a plurality of products and thereby determining an updated product location map S4130. Herein, blocks S4110, S4120, and S4130 may be variations of one of S110, S120, S130, and/or S140, and any suitable variation described herein may similarly be used with such a method variation. In this variation, location-to-product data associations can be built up during distributed usage of the application, in this case by customers using the application to scan products for purchasing.

A product selection action for a scan-and-go app can include scanning a products barcode or product code using a camera or entering product information manually. Product selection action for a scan-and-go app may alternatively include collecting image data of a product or products for adding to a checkout list, which results in processing of the image data, using a computer vision model in identifying the product(s), and adding the product(s) to the checkout list. Using the assumption that an item is added adjacent to or near where the product was selected, location data is preferably collected directly proceeding and/or at time of adding the item to the checkout list of the scan-and-go app. Variations described herein for S110, S120, S130, and S140 may additionally be included and used in such a method applied to a scan-and-go application implementation. This variation illustrates a variation where a product list is not known ahead of time, but product associations can be made because the operation of the application includes identifying the product. An application or device used by workers for performing inventory related tasks could similarly be adapted as a type of application used in a similar manner. In such variations, the application may be used for identifying products for operational reasons instead of for building a checkout list as in the scan-and-go checkout application variation.

As described herein, different method variations may use different approaches to determining and collecting location information. In some variations, location data points are based on sensing or tracking location of the user and/or the mobile computing device. In other variations, location data points may use image data collected from the device, such as image data collected as part of usage an application facilitating fulfillment of the order.

The mapping between products and location data may be substantially one-to-one where collected location data is linked to one or more specific products. In one such variation, the location data points may use temporal associations between the state of an application tracking fulfillment of an order to associate specific products with specific location data points.

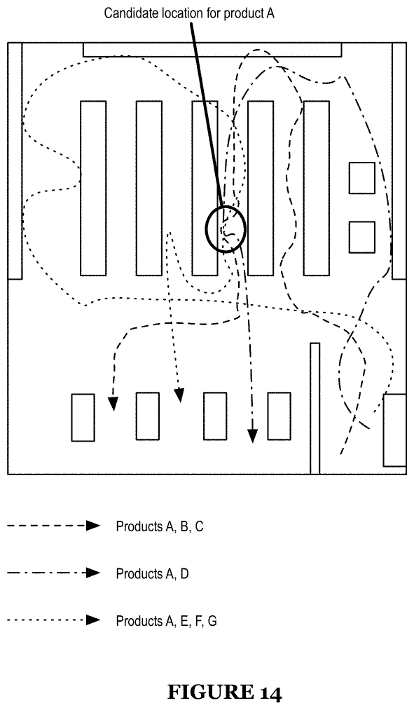

In other variations, use of the method may not depend on specific, differentiated mapping between products of a product list and location. For example, the tracked path of movement of a user through a retain environment may be associated as potential locations for all products of a product list as shown in FIG. 14. The accumulation of such location data may be used to detect patterns indicating the stocking location of products. As shown in the simplified representation of FIG. 14, overlapping paths with a shared product may indicate that location is a candidate for where that product is location. In this example, three paths may each have product A associated with them. The location where the paths overlap may be a location of the product A.

The method may be used in creating a map, but the method may additionally or alternatively be used in updating an existing map. The existing map may be a product location map created using the method. The existing map may alternatively be a product location map generated or supplied using another process. For example, the method may be used to maintain a manually created planogram by using an initial planogram (initial product location map).

Block S110, which includes associating a product list with an associated user, functions to determine product identifiers to be linked with a user that will be used for collecting location information. Herein, products of a retail environment are used as an exemplary type of object, but the system and method can similarly be used for any type of identifiable type of object.

The product list may be associated with a user but may be more specifically associated with a user account and/or a mobile device of a user.

In some variations, the product list may be “predetermined” (e.g., set prior to the user interacting with products) and the product list is assigned to a particular user or otherwise associated with the user at the beginning of their visit to the retail environment. in some cases, a user may receive the product list during their visit but prior to interacting with the products (e.g., collecting the products in the product list). Such variations may then track fulfillment of the intended shopping list.

In another variation, the product list may be determined and associated with a user incrementally. The product list may itself be determined and built up through actions of the user. For example, as a user selects a product, that product may be added to the product list associated with the user. Scan-and-go checkout applications may use this variation.

In a “retroactive” variation for how a product list is associated with a user, associating a product list with an associated user may occur retroactively to interactions between the user and products of the product list. In one example, location of a user may be tracked during their visit with the store (possibly with zero knowledge at the time of location tracking what products are being selected for purchase), and then when the user completes a checkout procedure, the product list generated by a receipt of the checkout procedure can be associated with the locations along the path taken by the user. In one exemplary implementation, an order fulfillment app could simply implement location tracking during fulfillment and then map that to the end purchase made by the picker. This variation may map all products of a product list to the locations along a path of the user and then isolate their likely location by comparing to other paths.

In one variation with a predetermined product list, the product list is generated as a result of a digital order. The digital order can include a set of products (e.g., one or more products) that are assigned to a user for selection. This user is described herein as a picker for some use cases, which could be someone who would pick up the items and then deliver the items to an end customer. The picker could alternatively be someone who otherwise assists in the collection of an order or part of an order. For a retail order fulfillment service, a picker may be managing one or more orders at a given time. Accordingly, a product list assigned to a picker may in fact be a set of products from multiple distinct delivery orders.

Accordingly, associating the product list with an associated user, in some variations can include: receiving, through a digital delivery ordering service, a plurality of orders, wherein each order includes a product list of product for delivery from a retail environment; and assigning each of the plurality of orders to a user account of a plurality of user accounts for fulfillment of the orders, with each user account being associated with at least one application instance on a distinct device for each user account. The users may use their respective application instance on their device to review and update status of the products in the product list.

In another variation with a predetermined product list, the product list may be part of a personal or shared shopping list of an end customer. For example, a shopping app may enable users to manage their shopping lists. Such an app may be offered by a grocery store or any suitable entity, for example. When using such an app, a user may cross off items as they are picked up (or marked as not available).

In another variation exemplifying incremental determination of a shopping list for a user, the shopping list may be built during the shopping visit. For example, a scan-and-go type application that enables customers to scan items as they shop to facilitate checkout, could be used to build a product list as the customer uses the application. In such a variation, the block S110 and/or the method more generally can include providing a scan-and-go checkout application interface to a plurality of users. Then, associating a product list with a user can include through the scan-and-go application interface of a user, entering products and adding the product to the product list of the user. Entry of a product may include scanning a product by scanning a barcode/product identifier, manually entering product identifying input, detecting identity of a product by analysis of collected image data (e.g., taking a picture of one or more products being purchased), and/or otherwise identifying a product to add a product identifier. The product scanning task will preferably trigger a location detection task through the mobile device, wherein detected location information can be associated with the scanned/entered product.

As another example of incremental determination of a product list, a stocking device or application could similarly be used to collect product information on demand as a user interacts with products. For example, a specially configured barcode reader app or device used for scanning products during inventory/operation tasks (e.g., stocking or inventory counting) could read product identifying information and detect location of the device.

As an exemplary variation of retroactively associating product lists and users, the shopping list may be generated after product selection and/or after a shopping visit. One example of such a scenario can be where a shopping list associated with a user is generated as a result of a checkout event. A point-of-sale checkout system may generate a list of items purchased by a user, and that list of items can be associated with the user. The locations visited by the user during the shopping visit can then be associated with those items.

In some variations, the interactions with the application and in particular product-associated interactions in the application may be used to provide more product-specific location information as part of block S120.

In some other variations, a list of products associated with a shopping visit may not depend on also having product specific events. For example, data on the list of items expected to be associated with a particular trackable user may be sufficient to build a product location map. For example, the tracked path or set of locations of a user during a shopping visit could be associated with a set of products from the shopping list. With sufficient data, individual product locations can be determined through the concentrations of product-location evidence for an individual product.

Block S120, which includes collecting location data of the user during activity with the product list, functions to detect location information of a user or more specifically a device of a user. In general, the location of a user is inferred by the location of a mobile computing device used by the user. This mobile computing device may include a user application that is used to manage the collection of location data. The user application may additionally be associated with a user accounts such that a product list may be associated with it. Alternatively, the user application may store and/or manage the product list.

The location data of a user may be continuously or periodically collected during a shopping visit to a retail environment. In some variations, the location data may be discrete locations from a particular time. In other variations, the location data may be a collection of points or even a path between points defining a timeline or locations within some time window. Alternatively or additionally, location data could be collected in response to particular events. For example, marking a product as added to a cart within an application could trigger collection and/or storage of location data at that time. In this example, the collected location data may be specifically associated with the product marked through the application. In other words, a product associated with a location data point can be a product associated with the current application state (e.g., a product associated with some user application event, the product with focus within the application. For example, a data record could be stored in a database indicating the location information (e.g., coordinates) and a product identifier. Additionally or alternatively, location information preceding or after that event may also be collected and associated with the product. In many scenarios, the location information is collected within some temporal window around the time of the event. That temporal window may be less than 1 second, less than 5 seconds or less than 10 seconds or any suitable time window. In some cases, tracked motion of the user (indicated by an IMU or other motion sensing system of the device) may also be used to dynamically determine the appropriate time to use the location information.

In some variations, location data is collected and stored in association with specific products of a product list. In this way, each product from a product list may have distinct location data that is collected. For example, a first location data point may be collected for milk from a delivery order, a second location data point may be collected for cereal from the delivery order, and a third location data point may be collected for a bag of apples from the delivery order.

In some cases, multiple products may be associated with the same or shared location data. For example, if a user checks off two products within an order fulfillment application without significantly moving (e.g., within the same 2 meter radius) then the same location data may be collected for both products as those two products may be stored in nearby spots.

In other variations, location data may be collected and stored in association with a product list more generally. This variation may lack product specific signals to differentiate which products correspond to different locations visited by a user during their time in the environment. In this variation, a set of location data may be associated with each product in the product list as shown in the example of FIG. 14. Processing and analysis implemented through block S130, may be used to predict individual product locations. As described below, the collection of location data over a sufficient number of orders may reveal location of a product because each path related to a product would overlap with one or more of the product's location in the store.

In a variation collecting location data directly associated with a specific product, block S120 may include detecting location of the mobile device while completing fulfillment of the order S1120 resulting in an association of location with product identifiers. In the context of an order fulfillment service, S120 may include determining an order to be undergoing fulfillment in association with a mobile computing device linked with the user account of the order, and, during fulfillment of the order, collecting location data points for products of the product list using input from the mobile computing device.

Associating products of a product list with product-specific location data usually involves using events triggered through a digital interaction. Block S120, accordingly, may include providing a user interface that receives user input events signaling points in time when the user (e.g., the mobile device or a user account) is expected to be in proximity to a product or an expected location of the product (even if the product is out of stock). In this way, during fulfillment of each order: block S120 can include receiving user input through the device updating product-fulfillment status of a product of the order (e.g., picked, not available, etc.) and associating the product with detected location data as shown in FIGS. 8-10. Location data could be detected by using a location service of the device (GPS, RF triangulation, etc.) or using visual data to predict location. The detected location data may be detected at the time of user input is received. The detected location data may be detected preceding the time of user input or following the time of input. In one preferred variation, a location service of the device is queried in response to the received user input.

In some instances, the input triggers a camera whereby the image may be used to detect the location either by extracting location information from the image data or using the time of the image of the product to determine when the location data should be collected as shown in FIG. 9. When the product is available and is selected, the user input may indicate the user has acquired the product (and presumably is in proximity to the stocking location of the product). When the product is unavailable then the user input may indicate the product is not near the location of the user. A negative location data point or some alternative data record may be stored to indicate when a product is not found at a location.

The user input may also be used to determine one or more products to associate with location information. In general, the user input may be associated with a particular product. For example, the user input may be graphically represented in a user interface of an application with to indicate the context of a particular product to indicate that interactions with the user input are associated with the corresponding product. As shown in FIGS. 8 and 9, the user interface presents Acme O's as the product in focus within the application, and actions taken in that view can be used to collect location data points for at least Acme O's

The user input may be provided in a variety of ways.

For an order fulfillment serviced, the user input may be user interface elements to mark if the user picked up an item successfully or if there was an issue (i.e., indicating picking status of a product). Interactions within this interface may be used to trigger location detection. In some variations, image capture may be used as a mechanism for confirming product selection or unavailability.

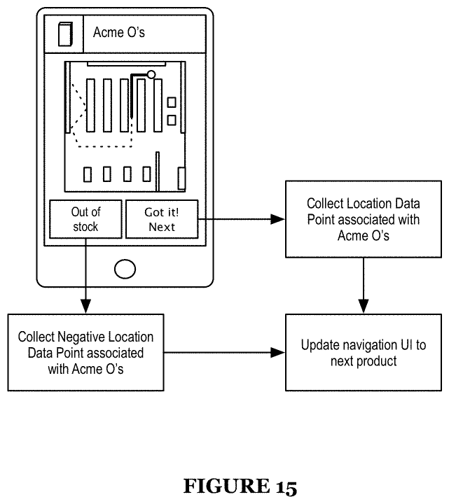

In another variation, a product list may be used for providing routing instructions to assist the user in efficiently navigating through the store to pick up the items from the product list. This variation may include delivering navigational instructions for locating of products of the product list (the navigational instructions may be based on the product location map). When interacting with the app, the next product may be presented as the next target within the navigational interface. A user input may be provided in the navigational user interface to mark the state of that product (e.g., collected or not available) and to move to the next target product. Interactions to update the navigational UI may also be used to update the fulfillment state of the product list and to collect location data points for the current product as shown in FIG. 15.

In a scan-and-go checkout application, the user input may be the scanning action to add a product to the user's checkout list. Scanning an item may both collect product identifying information to add it to the product list and also trigger collecting location information to store as a location data point for the product.

Collecting the location data preferably includes detecting location using the mobile computing device. Detecting location can use one or more location detecting mechanisms including reading location information from a location service of the mobile computing device (e.g., using whatever location information offered by the device); reading GPS location information, performing; wireless communication triangulation; magnetic sensing; position tracking using accelerometer, gyroscope, and/or other type of inertial measurement system; detecting location through RFID tracking; performing Bluetooth proximity/location tracking; performing ultra-wide band (UWB) location tracking; detecting relative position to one or more beacons in the environment; performing computer vision location tracking; and/or other location detection techniques.

Collecting location data points can include reading location information from a location detection service of the mobile computing device. This may include reading GPS (global positing system) location, using Wi-Fi triangulation, RF triangulation, using UWB positioning, acoustic triangulation, beacon triangulation, and/or other wireless positioning/locating systems. This location data may be global location information, but may alternatively be relative location information. Reading location information from a location detection service of the mobile computing device may be triggered in response to an event. Alternatively, reading location information may be continuously or periodically performed during the visit.

Collecting location data points may, in some variations, include tracking location using visual location tracking of the mobile computing device. This variation can include collecting image data and processing the image data to determine location.

Visual location tracking may use continuous tracking to track movement of the mobile computing device through the environment. This preferably tracks motion of the user through the environment. This variation may additionally use other motion orientation sensor inputs such as an inertial measurement unit (IMU), accelerometer(s), gyroscopes, magnetometers, lidars, structured light/depth sensing devices, and/or other sensor inputs. The visual tracking may use inside-out tracking, visual SLAM (Simultaneous Localization and Mapping), visual odometry, structure-from-motion (SfM), and/or other techniques. Such visual location tracking may particularly be useful in devices such as AR/smart glasses or other mobile computing devices with imaging capabilities.

In some variation, an application used for order fulfillment may enable image capture as a step in fulfilling an order. For example, a picker may have to take a picture (or video) each time a product is selected to document selection of a product. If a product is not available the picker may additionally be requested to take a picture (or video) of the display region showing the product to not be available (e.g., out of stock or damaged inventory). This application interaction may be used to automate steps in the app of confirming identity of the product and extracting location information from the images.

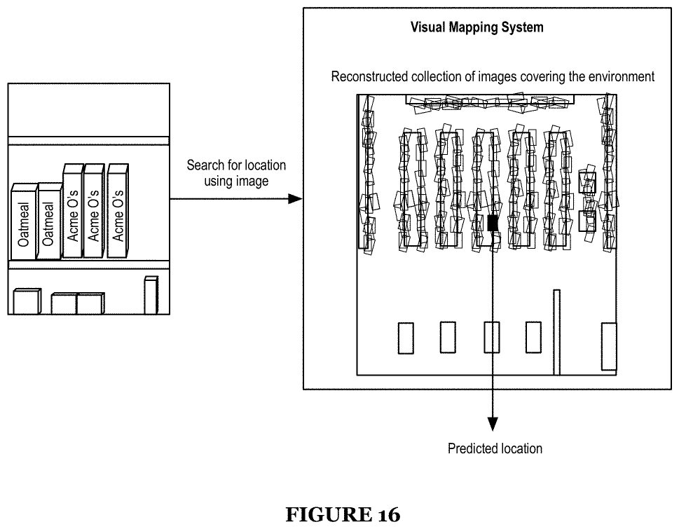

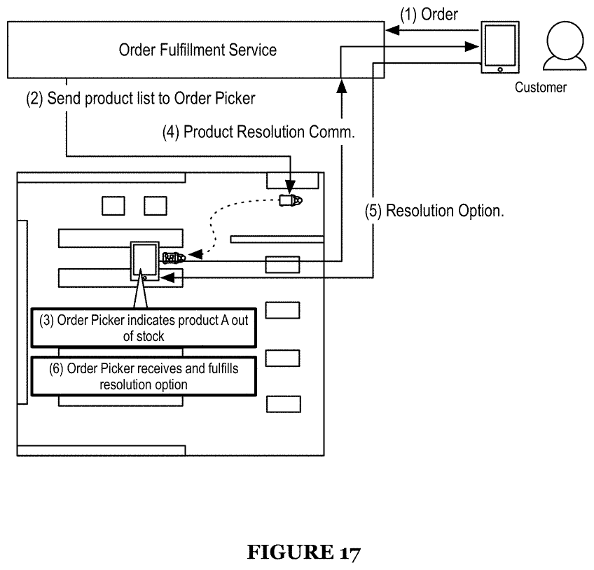

Visual location tracking may alternatively predict location by performing location prediction analysis on one or more isolated images. This variation may use an image collected in association with one or more products and map that image to visual map of the environment. The images will generally be associated with particular product-related events. Accordingly, collecting location data points may include: collecting (using an imaging device of the mobile computing device) image data associated with a fulfillment state of a product of the order and processing collected image data for determining at least one location data point associated with the product as shown in FIGS. 9 and 16.

Collecting image data may be performed in association with a mobile computing device, where the mobile computing devices has an application state for a particular product (e.g., within an order fulfillment application). The application state may be used to link the image to the product. In an exemplary variation of block S120 using product-specific images may include: at an order fulfillment application, entering a fulfillment input state for a first product (e.g., the application taking a picture to catalog the picking state of a product), collecting image data during the fulfillment input state for the first product, and associating the image data with the first product. Then the image data is analyzed to predict a location of the image data.

Analyzing the image data may include querying a visual mapping system using the image data as shown in FIG. 16. Querying a visual mapping system may use SLAM or other visual mapping/locating techniques. The visual mapping system may be a database system that can be used to determine location or an image by matching patterns in an image to patterns from a collection of images covering the environment. For example, searching for an image of a particular section of a shelf in a first aisle will analyze all images covering a dispersed region (if not the entirety) of the environment and determine a likely location. In one variation, mapping the image data to a location from a collection of images with overlapping coverage in the environment, wherein mapping the image data identifies at least one location with matching visual features (e.g., a higher match of visual features compared to other possible locations). In another variation, querying the visual mapping system may involve extracting image location features.

For some retail environments, a customized visual mapping system may leverage the regular patterning of products on shelves. Such a variation may include processing of the image data that includes identifying multiple stoked products in an image, forming an image location signature based at least in part on the multiple stocked products in the image, and searching a visual mapping system, where the visual mapping system is indexed at least partially based on stocked locations of product. For example, an image capturing a shelf may have multiple products identified. Those product identities may be used to find a corresponding location based on other images that captured those products or subsets of those products. In such a product identity searching approach, the arrangement of the products may also be factored into the searching and indexing.

The collection of product-associated images, may additionally or alternatively be used for other automated features such as collecting location data for adjacent products in the environment, automatically entering product identifier information or confirming product identity, managing a product list, detecting product selection errors, auditing picker performance, automating customer interactions in cases of issues, and/or other possible features.

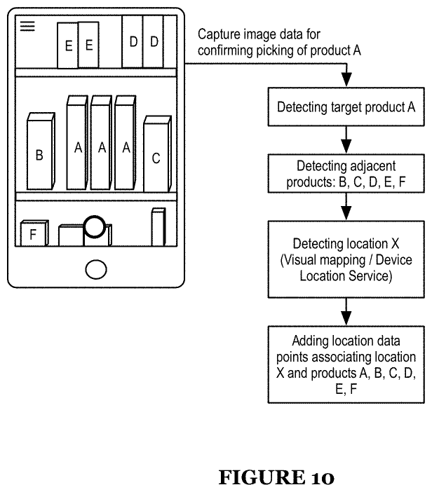

In one variation, image data may be used to determine products adjacent to the intended product and use this to build out location data for more products. Image data captured by a user may be processed using automated product identification processes such that other products captured in the image data (e.g., adjacent products) could also be identified and associated with location information. Accordingly, collecting location data points may additionally include collecting image data for a product, and detecting additional products in the image data and storing location data points for the additional products as shown in FIG. 10. For example, a picker or customer may take a photo of a product as part of an app interaction to confirm or otherwise indicate product selection. Products in the background of the image data may also be identified and associated with location information retrieved by the mobile device. This variation functions to enable location information to be detected and stored for products outside of the product list. This variation may be used with different ways of collecting location data—visual locating of the image or location services of a device may also be used. For example, a product list including a product A may result in a picker taking a picture of them holding product A with adjacently stocked products in the background. The location of the picker's phone may be detected using GPS, wireless positioning technique, image location prediction, or any suitable locating mechanism. Additionally, the image may be analyzed to identify a set of other products that were adjacently stocked (as captured in the image data), and location data for those products can similarly be stored within the database system.

Images of shelves and other stocking configurations may also be extracted from image data so that stocking/shelf specific locations can be determined and integrated into the product location map. Analyzing the images may include identifying other products in the image data and the stocking arrangement within the image data (e.g., shelf placement, product ordering, etc.).

In another variation, product-associated images may be used for entering product information. An image may be captured focused on one or multiple items. Focus here may be determined by the user holding a product or otherwise arranging the item to be the prominent object (e.g., being the product taking up the most space visually in the image), arranging the product as the main item in the foreground, aligning a target point or region with the product or an identifying element of the product (positioning the front face of a product within a centrally located, highlighted box), or identifying the item for identification in other suitable ways. Visual identification can be performed by matching the packaging or visual properties of the product to a visual database of products. This may be used in place of or in combination with barcode/product identifier reading. When the product list is predefined, identifying the product may be used to confirm the product selected matches the product in the product list. In some cases, the product list may be used to more efficiently identify the product. When the product list is being built up, then the image capture of the product may be a mechanism for entering product information. Barcode scanning or manual entry may additionally or alternatively be used.

In a related variation, analysis of the image data may be used to automate management of a product list within an application. Image data is analyzed to confirmed if it matches a product from the product list. Confirming a product in the product list matches the product in an image may additionally update the application state to indicate the product was selected (e.g., adding to checkout list, crossing off from shopping list for the user). This may be visually represented in a graphical user interface. This may also be used for triggering other updates to the user interface and/or state of the application. In one example, confirming selection of a product results in updating navigation or instructions to next product. The next product may dynamically be determined based on recommended routing for fulfilling products of the remaining product list.

Similarly, the image data may be used to confirm product unavailability. If a picker cannot find the product in an expected location because the product is out of stock, product is a damaged, or otherwise is determined not suitable for selection, the application may direct the picker to take a picture as confirmation. This may be triggered when the user selects a user interface input indicating the product is not available. The collected image data may be analyzed to confirm the product is unavailable. In the case of confirming out of stock state for a product of the product list, the image data may be analyzed to confirm the image data is of the expected product stocking location and then confirming product is not present as. Confirming the image data is of the expected product stocking location may include confirming location data matches expected location data (either using visual image search and/or location services of the device) as shown in FIG. 9. In another variation, the adjacently stocked products may be used to confirm the image is of the correct location. The image data analysis may also detect an out of stocked product section of a shelf where the product is expected. When historical image data is available, a comparison to previous image data from when the image was in stock may also be used to confirm the stocking of the product has changed.

Accordingly, a method variation that responds to product confirmation or indication of product unavailability may include: collecting (using an imaging device of the mobile computing device) image data associated with a fulfillment state of a product of the order; and after collecting the image data, processing the image data to determine presence of the product; if product is determined to not be present, determining location of the image and confirming the location of the image covers an expected location; if product is determined to be present, storing the location data point associated with the product. In some variations, confirming the product is not present may result in logging a negative indicator of product location. Storing location data on where a product is not found may be useful for determining when a product location changes, which may be used in disregarding old location data indicating the product was found there. Confirming the product is present and/or confirming the product is not present may be used to automatically update the fulfillment state of the product within the application: marking the product as added if present and marking the product as not available if product is not present. The method may additionally include processing the collected image data for determining a location data point associated with the product. However, such image processing may be used in combination with other location detection techniques.

In another variation, analyzing the image data may also include detecting or flagging misalignment or issues with the product selection and a product from a product list. This may be used to detect when a product doesn't match exactly the product. The size or quantity may not match. The flavor or product variation may differ from specified product. For example, if the user selected chocolate flavored granola bars but the product identified in the image is an oatmeal raisin granola bar, an alert could be triggered.

In a related variation, such analysis of image data may be used to evaluate quality of product selection by a picker. The automated checks can be used to ensure that pickers are visiting expected locations of a product when they indicate the product is not available. The automated checks may also detect when the proper product is not selected.

In other related variations discussed more for related actions using the product location map, analysis of the image data may be used to automatically trigger different digital interactions. This may particularly apply to variations used in connection with an order fulfillment service.

As one responsive action, if a product is confirmed to not be in stock, then a response may be triggered within the order fulfillment service as shown in FIG. 16. In one variation, in response to detecting a product as not available or another inventory availability issue, triggering a product resolution interaction through a digital interaction. Detecting a product is not available or an inventory availability issue may include detecting a product not present in collected image data and the location of the image is confirmed to match an expected location of the product. The digital interaction may include sending a communication to a communication endpoint of a creator of the order (e.g., the end-customer). The creator of the order may receive a notification or alert on their phone, app, or other communication device. Optionally, the method can include receiving input on a preferred resolution option. A resolution option may be an order update such as “cancel item”, “buy a different product”, or any suitable order update. In this way, an end-customer could indicate their preference of skipping the item, purchasing a substitute item, or performing some other resolution.

The system may rely on such out-of-stock information to resolve issues not just with the order for which the issue was discovered but also related orders that could similarly be impacted. Pending orders that include a product with an availability may similarly have a product resolution interaction triggered where the end-customer is alerted to product availability issues.

Variations where related orders are resolved may include: detecting a product as not available or another inventory availability issue; determining a set of pending orders impacted by availability issue of the product; and triggering a product resolution interaction for the set of pending orders. Similar to above, this may include sending a communication to a communication endpoint for each creator of the set of pending orders. The communication may present different resolution actions the creator of the order may make, and the method can include receiving, for at least a subset of the pending orders, input on a preferred resolution option. In some cases, this may allow the order fulfillment service to resolve the issue prior to the picker of some orders from even noticing the change to the order.

Some variations may use product stocking information extracted from the image data and/or the product location map to generate different resolution options. For example, one variation can include processing the image data and detecting products adjacent to an expected stocking location of product and using the detected additional products to communicate alternative product options as potential substitute product options to the creator of the order. In an alternative approach, a variation may include sending an image from the image data directly so that the user can inspect the image determine how to respond.

Collected image data may also be used to update inventory availability status. Analyzing collected image data may not just detect presence or lack of presence of a product. The image data may be analyzed to predict inventory quantities. Inventory quantities may be predicted for products of interest but can also be generated for adjacent products captured in the image data. Online ordering interfaces may be updated accordingly to reflect inventory data. For example, a warning may be added to certain products with low inventory when the customer is browsing options to create their order.

The location data may be collected and stored in its original raw format, but the location data may alternatively be pre-processed and stored in a condition for better mapping of product locations. Alternatively, the location data may be pre-processed as part of analysis and generation of the product location map S130. This may function to normalize the location data for predicting stocking location of products in a retail setting.

In some variations, a collection of location data points may be analyzed to identify one or more product locations to store as location data for the product. More specifically, this may include analyzing location data from a window temporally preceding or proceeding the application event, and identifying locations correlated with a potential product location.

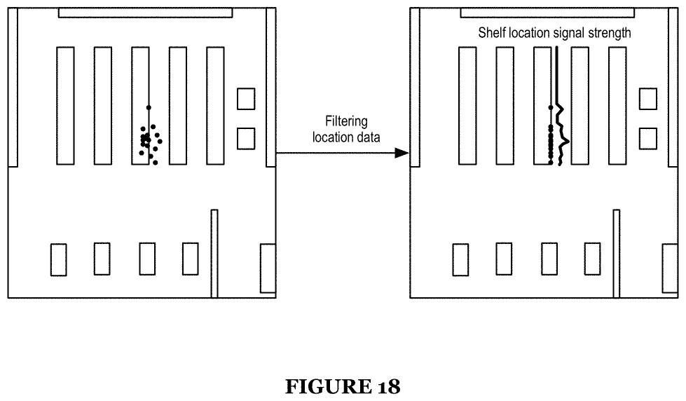

In another approach, the location data may be filtered to remove location data noise. This can include mapping location data to possible product stocking locations as shown in FIG. 18. For example, a location data point from the middle of an aisle in a grocery store may be mapped to a nearest shelf.

Block S130, which includes processing data associations of the product list and the location of the user and generating product location map, functions to create a prediction of product location based on observations of patterns in location data for products. Processing the data associations is preferably used to generate location predictions.

Processing data associations of the product list and location of user preferably leverages a location dataset that is built during S120. As discussed above for S120, various techniques may be used to construct a location dataset that provides robust data for possible locations of products. Accordingly, S130 may include processing a location dataset for associations between the location data points and products and thereby determining an updated product location map. This can include detecting patterns in observations of location datapoints for products to predict a location of a product. Number of location data points, distribution of location data points, and/or recency of location data points for a product may be factored into location predictions for the product. In some variations, negative location data points may be stored to indicate where a product was not found. A negative location data point may be used to indicate change in stocking conditions if a product is out of stock or stopped being stocked in a particular condition.

In some instances, a product would have one associated location for an order or shopping visit (e.g., resulting from when that item was picked up or interacted with). In some variations, however, there may be multiple locations associated with a product for a given order or shopping visit.

In one variation, the resulting product location map is modeled as a set of location points across an environment with a set of product predictions for each location. The product predictions can be predicted as confidence or likelihood. This data model can be queried to identify a set of locations likely for a given product identifier. In some variations, a location may be queried to return the expected product (or a list of candidate products—possibly ranked by confidence scores).

In one variation, the set of data associations can be used as a dataset against which different queries can be made. For example, the data model can be analyzed dynamically based on the type of query.

Determining a product location map with high reliability and/or coverage will generally depend on having sufficient data. A product will need to have at least one location data point to be mapped using the methods location information. There will preferably be multiple location data points to provide higher confidence in a products location. The location data point may be stored because the product was part of a product list. The location data point may also be stored when the product was identified as an adjacent product in collected image data.

The updated product location map may be implemented in different ways.

In one instance the product location map may be a queryable service. The queryable service may operate on top of the raw location data point data collected as part of building the location dataset. The queryable service may alternatively use cleaned/preprocessed location data point data, which may be normalized to map location data points to possible storage locations and/or removing noisy data points or possible errors.

In another instance, the product location map may be an output after processing the location dataset. In one such variation, the product location map may be a predicted planogram.

As the method may be performed iteratively, new updates to the location dataset may be used to update the product location map.

In some variations, the method may be performed to update an existing product location map. In this way, the method may have an existing map of expected product locations. This pre-existing product location map may be updated in block S130. In another variation, differences may be flagged between a product location map output from the method and the pre-existing product location map.

In some method variations that include collecting image data of products, the image data collected from multiple points within the environment may be used to construct a visual map of the environment. Block S130 and/or the method more generally may include building a map of the environment by combining image data collected for multiple products into a multi-dimensional representation of the retail environment, wherein the product location map maps product identifiers to the multi-dimensional representation. The multi-dimensional representation may be a 3D representation, a 2D representation in others, or other types of representations. Building the map may use photogrammetry, neural radiance fields (NERFs), multi-view stereo (MVS), Multi-image matching, Visual Simultaneous Localization and Mapping (SLAM), and/or other suitable techniques to match up the images to reconstruct a multi-dimensional reconstruction of the environment. In some cases, retail environments may have significant contextual information exposed by the nature of the environment such as aisle labels, shelf labels, product organization, signage, etc. This contextual information may be used as metadata when organizing image data into a spatial representation of images. Once a visual map is created, then individual images may be searched against the visual map to predict location of a specific image.

The data associations may be filtered, weighted, coalesced, or otherwise pre-processed to clean data. For example, some location data associated with a product could be filtered and removed when it is unlikely to provide useful information. For example, erroneous data could be filtered out.

In a related variation, block S130 may include weighting data associations by time. This can be used to give higher preference to more recent product location data. This can be used so that the data modeling of product location can react faster to changes in product locations.

Also discussed, the location data may be pre-processed to map location data points to possible stocking locations. This may be used to align location data (which may be slightly inaccurate) to actual stocking locations. For example, indication that a product is in the middle of an aisle would be cleaned to move the product to the nearest shelf on the aisle. Cleaning of location data may happen on individual location data points or may be performed after analyzing a collection of location data points.

Block S140, which includes using product map, functions to use the resulting product map in one or more different ways.

Using the product map may include generating a product map representation. This could be a graphical map, a searchable product location database, or any suitable user interface that can be used to represent locations of the products. The generated product location map may be represented as a digital user interface which can be interacted with. Queries may be made for particular products or types of products.

Using the product map may additionally or alternatively include flagging products for low inventory or out-of-stock status, product stocking changes, and/or other changes based on product availability and location.

Using the product map may additionally or alternatively include directing subsequent users to product locations based on the product location map. This can similarly be used for route-planning. For example, a picker with a shopping list could have a route generated and presented to them for more efficient product picking. When used in connection with an order fulfillment service, block S140 may include: for least a subset of orders, during fulfillment, delivering navigational instructions for locating of products of the product list, the navigational instructions being based on the product location map.

In an alternative and/or additional variation, the method can also enable special functionality within order fulfillment by a retail order fulfillment service. Within retail order fulfillment services, out of stocks or product non-availability can result in poor user experiences when the end customer doesn't receive a requested product and/or receives a substitute product. The method with its self-updating data model of inventory status can react to different situations to automate resolution of such events. For example, the method may reactively detect or predict when an item in an order may suffer from availability issues. Accordingly, the method can include, upon detecting inventory availability issue, triggering a product resolution interaction through digital interaction with a user. Triggering a product resolution interaction can include sending or otherwise communicating with a customer of the potential issue, and/or optionally receiving input on preferred resolution options. In this way, a customer could indicate their preference of skipping the item, purchasing a substitute item, or performing some other resolution.

4. System Architecture

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

In one variation, a system comprising of one or more computer-readable mediums (e.g., non-transitory computer-readable mediums) storing instructions that, when executed by the one or more computer processors, cause a computing platform to perform operations comprising those of the system or method described herein such as: associating a product list with a user; collecting location data of the user during activity with the product list; and processing for associations between the product list and the location of the user and generating an updated product location map, and/or using the product location map.

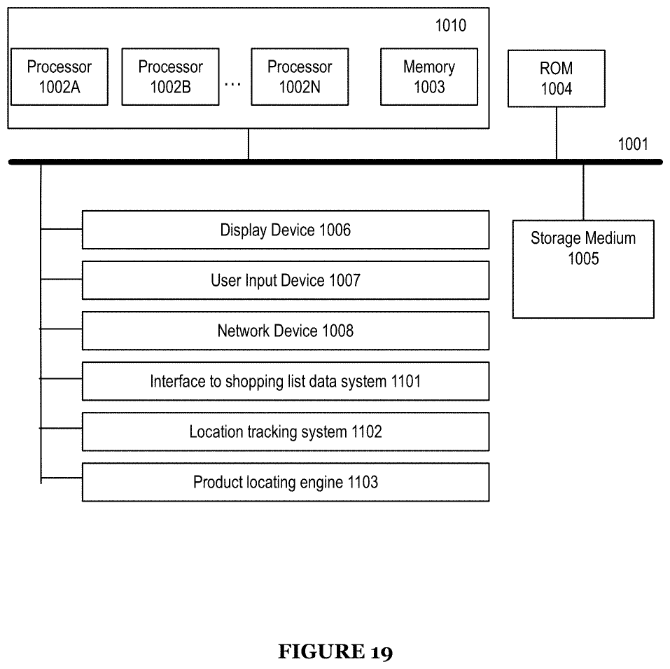

FIG. 19 is an exemplary computer architecture diagram of one implementation of the system. In some implementations, the system is implemented in a plurality of devices in communication over a communication channel and/or network. In some implementations, the elements of the system are implemented in separate computing devices. In some implementations, two or more of the system elements are implemented in same devices. The system and portions of the system may be integrated into a computing device or system that can serve as or within the system.

The communication channel 1001 interfaces with the processors 1002A-1002N, the memory (e.g., a random access memory (RAM)) 1003, a read only memory (ROM) 1004, a processor-readable storage medium 1005, a display device 1006, a user input device 1007, and a network device 1008. As shown, the computer infrastructure may be used in connecting an interface to shopping list data system 1101, location tracking system 1102, product locating engine 1103, and/or other suitable computing devices.

The processors 1002A-1002N may take many forms, such CPUs (Central Processing Units), GPUs (Graphical Processing Units), microprocessors, ML/DL (Machine Learning/Deep Learning) processing units such as a Tensor Processing Unit, FPGA (Field Programmable Gate Arrays, custom processors, and/or any suitable type of processor.

The processors 1002A-1002N and the main memory 1003 (or some sub-combination) can form a processing unit 1010. In some embodiments, the processing unit includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some embodiments, the processing unit is an ASIC (Application-Specific Integrated Circuit). In some embodiments, the processing unit is a SoC (System-on-Chip). In some embodiments, the processing unit includes one or more of the elements of the system.

A network device 1008 may provide one or more wired or wireless interfaces for exchanging data and commands between the system and/or other devices, such as devices of external systems. Such wired and wireless interfaces include, for example, a universal serial bus (USB) interface, Bluetooth interface, Wi-Fi interface, Ethernet interface, near field communication (NFC) interface, and the like.

Computer and/or Machine-readable executable instructions comprising of configuration for software programs (such as an operating system, application programs, and device drivers) can be stored in the memory 1003 from the processor-readable storage medium 1005, the ROM 1004 or any other data storage system.

When executed by one or more computer processors, the respective machine-executable instructions may be accessed by at least one of processors 1002A-1002N (of a processing unit 1010) via the communication channel 1001, and then executed by at least one of processors 1001A-1001N. Data, databases, data records or other stored forms data created or used by the software programs can also be stored in the memory 1003, and such data is accessed by at least one of processors 1002A-1002N during execution of the machine-executable instructions of the software programs.

The processor-readable storage medium 1005 is one of (or a combination of two or more of) a hard drive, a flash drive, a DVD, a CD, an optical disk, a floppy disk, a flash storage, a solid state drive, a ROM, an EEPROM, an electronic circuit, a semiconductor memory device, and the like. The processor-readable storage medium 1005 can include an operating system, software programs, device drivers, and/or other suitable sub-systems or software.

As used herein, first, second, third, etc. are used to characterize and distinguish various elements, components, regions, layers and/or sections. These elements, components, regions, layers and/or sections should not be limited by these terms. Use of numerical terms may be used to distinguish one element, component, region, layer and/or section from another element, component, region, layer and/or section. Use of such numerical terms does not imply a sequence or order unless clearly indicated by the context. Such numerical references may be used interchangeable without departing from the teaching of the embodiments and variations herein.

As a person skilled in the art will recognize from the previous detailed description and from the figures and claims, modifications and changes can be made to the embodiments of the invention without departing from the scope of this invention as defined in the following claims.

We claim:

1. A method for mapping product locations comprising:
receiving, through a digital delivery ordering service, a plurality of orders, wherein each order includes a product list of products for delivery from a retail environment;
assigning each of the plurality of orders to a user account of a plurality of user accounts for fulfillment of the orders;
building a location dataset associating location data points and products, comprising for each order:
determining an order to be undergoing fulfillment in association with a mobile computing device linked with the user account of the order,
during fulfillment of the order, collecting location data points for products of the product list using input from the mobile computing device; and
processing the location dataset for associations between the location data points and products and thereby determining an updated product location map.

2. The method of claim 1, wherein collecting location data points for products of the product list using input from the mobile computing device comprises: through the mobile computing device, receiving user input that updates product fulfillment status of a product of the order and associating the product with detected location data.

3. The method of claim 2, wherein the user input that updates product fulfillment status of the product indicates if the product was collected or if the product is not available.

4. The method of claim 2, wherein associating the product with detected location data comprises determining location of the mobile computing device in response to receiving the user input.

5. The method of claim 1, wherein collecting location data points comprises retrieving location information from a location detection service of the mobile computing device.

6. The method of claim 1, wherein collecting location data points comprises tracking location using visual location tracking of the mobile computing device.

7. The method of claim 1, wherein collecting location data points comprises: collecting, using an imaging device of the mobile computing device, image data associated with a fulfillment state of a product of the order.

8. The method of claim 7, wherein collecting location data further comprises processing the collected image data for determining a location data point associated with the product.

9. The method of claim 8, wherein processing collected image data for determining the location data point associated with the product comprises querying a visual mapping system using the image data.

10. The method of claim 7, further comprising building a map of the retail environment by combining image data collected for multiple products into a multi-dimensional representation of the retail environment, wherein the product location map maps product identifiers to the multi-dimensional representation.

11. The method of claim 7, wherein building a location dataset associating location data points and products further comprises detecting additional products in the collected image data and storing location data points for the additional products.

12. The method of claim 7, further comprising, after collecting the image data, processing the image data to determine presence of the product; if the product is determined to not be present, determining location of the image and confirming the location of the image covers an expected location; if the product is determined to be present, storing a location data point associated with the product.

13. The method of claim 12, wherein if the location is confirmed as the expected location and the product is not present, triggering a product resolution interaction comprising: sending a communication to a communication endpoint of a creator of the order; and receiving input on a preferred resolution option.

14. The method of claim 1, wherein for at least a subset of orders, during fulfillment, delivering navigational instructions for locating of products of the product list, the navigational instructions being based on the product location map.

15. The method of claim 1, wherein processing the location dataset for associations between the location data points and products and thereby determining an updated product location map comprises detecting patterns in observations of location datapoints for products to predict a location of a product.

16. A non-transitory computer-readable medium storing instructions that, when executed by one or more computer processors of a computing platform, cause the computing platform to perform the operations comprising:
receiving, through a digital delivery ordering service, a plurality of orders, wherein each order includes a product list of products for delivery from a retail environment;
assigning each of the plurality of orders to a user account of a plurality of user accounts for fulfillment of the orders;
building a location dataset associating location data points and products, comprising for each order:
determining an order to be undergoing fulfillment in association with a mobile computing device linked with the user account of the order,
during fulfillment of the order, collecting location data points for products of the product list using input from the mobile computing device; and
processing the location dataset for associations between the location data points and products and thereby determining an updated product location map.

17. The non-transitory computer-readable medium of claim 16, wherein collecting location data points for products of the product list using input from the mobile computing device comprises: through the mobile computing device, receiving user input that updates product fulfillment status of a product of the order and associating the product with detected location data.

18. A system comprising of:
one or more computer-readable mediums storing instructions that, when executed by the one or more computer processors, cause a computing platform to perform operations comprising:
receiving, through a digital delivery ordering service, a plurality of orders, wherein each order includes a product list of products for delivery from a retail environment;
assigning each of the plurality of orders to a user account of a plurality of user accounts for fulfillment of the orders;
building a location dataset associating location data points and products, comprising for each order:
determining an order to be undergoing fulfillment in association with a mobile computing device linked with the user account of the order,
during fulfillment of the order, collecting location data points for products of the product list using input from the mobile computing device; and
processing the location dataset for associations between the location data points and products and thereby determining an updated product location map.

19. The system of claim 18, wherein collecting location data points for products of the product list using input from the mobile computing device comprises: through the mobile computing device, receiving user input that updates product fulfillment status of a product of the order and associating the product with detected location data.
